(19) United States
(12) Patent Application Publication
(10) Pub. No.: US 2007/0133142 A1
(43) Pub. Date: Jun. 14, 2007

(54) Automatic setting of the resonant frequency on demagnetization of different parts in demagnetization installations

(76) Inventor: Urs Meyer, Niederglatt (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/636,309

(22) Filed: Dec. 7, 2006

(30) Foreign Application Priority Data
Dec. 10, 2005 (EP) 05 027030.5

(51) Int. Cl. H01H 47/00

(52) U.S. Cl. 361/143

(57) ABSTRACT

For demagnetizing larger parts and charges, from about 1 kg mass, the wattless power of the demagnetization coil is so high that it is compensated with a capacitor. The capacitor for this is connected in series with the coil, and a pulse-width-modulated inverter of the usual construction type is applied for the supply. The demagnetization may be effected by impulse or by running through a magnetic field of a constant strength. The inverter in the first case produces a current impulse of a certain frequency, shape and duration. In the second case, it produces a certain constant current at a certain frequency. In order with a given exit voltage of the inverter to achieve the highest possible current in the coil, the produced frequency must correspond to the resonant frequency of the oscillation circuit. In order to ascertain the resonant frequency of the charged coil, this may be measured by way of a separate measurement coil with a small measurement current. Afterwards, the frequency in the oscillation circuit is set to this value for the demagnetisation procedure.

### FIELD OF THE INVENTION

The invention relates to a method for the automatic setting of the resonant frequency on demagnetizing different objects in demagnetization installations; according to the introductory part of the independent patent claim.

### BACKGROUND OF THE INVENTION

Residual magnetism in objects is becoming an increasing problem with today's use of materials for mechanical components, and the widespread use of sensitive electronic components and circuits. The collection of ferromagnetic particles on the edges of parts which have a residual magnetism is particularly unfavorable. Such particles in the micrometer range may only be brushed off, wiped off, blown off or washed off when the residual magnetism is eliminated. The residual magnetism present in objects has become a central quality criterion for suppliers of parts of steel or other material which is ferromagnetic to a lesser or greater extent, to machinery and car manufacturers. In particular, with mass-production of parts, the costs are reduced by way of modern manufacturing methods, such as for example electromechanical conveying, clamping, chucking, driving and likewise, and also on account of the material selection. The other side of the coin however is that other risks occur due to this, such as residual magnetism.

One known method for demagnetizing objects uses an open magnetic circuit, for example with a bar magnet or a magnetic yoke, and with a coil through which a constant alternating current flows. The magnetic circuit is applied to the object to be demagnetized and the alternating current is switched on. Thereupon, the magnetic circuit is pulled away from the object slowly by hand. The size and weight of the magnetic circuit is limited with this device. The demagnetization procedure is greatly influenced by environmental conditions. The demagnetization is incomplete and may not be perfectly reproducible.

With a further known method, according to DE 3718936 A1, one operates with a coil tunnel consisting of a large coil, through which alternating current constantly flows. The object to be demagnetized is pulled through the stationary magnetic field of the coil tunnel. By way of this, the object is subjected to the magnetic field firstly in an increasing manner and then in a decreasing manner. The demagnetization effect is limited however. The effect may be improved by a matching alignment of the objects to be demagnetized, but as a whole may hardly be reproduced in a perfect manner. The consumption of electrical energy and the cooling requirement are extremely high due to the continuous operation of the coil. Only a small part of the magnetic field is really utilized for the demagnetization effect.

In a further method, according to EP 1465217, the ferromagnetic objects as a whole are completely demagnetized in that they remain spatially fixed in the magnetic field of a coil for a certain time, and thereby are subjected to an alternating field of a decaying amplitude. Thereby, the alternating field of the coil is produced in a variable manner with regard to frequency and amplitude by an electronic supply source. During the time of presence of the objects in the coil, the alternating field is brought to zero from a maximum value in a continuously decreasing manner. The objects are then demagnetized to such an extent that residual magnetism may no longer be measured. The course of the demagnetization takes place in a cycled manner. This method has always proven its worth with objects to be demagnetized which are always of the same type, and also provides for the complete demagnetization.

It is particularly advantageous to supplement the demagnetization coil with a capacitor into a series oscillation circuit. For this, the capacitor is connected in series with the coil and a pulse-width-modulated inverter of the usual construction type is applied for the supply. With this, the inductive wattless power of the coil is compensated, and the supply source is relieved. This however presupposes an operation in the condition of the resonance of the oscillation circuit, which means that the frequency of the supply must correspond to the resonant frequency of the oscillation circuit. An additional problem arises from this, which is the fact that with a different loading of the coil due to the objects to be demagnetized, its inductance and thus also the resonant frequency of the oscillation circuit also changes.

If, as previously explained, the resonant frequency is not known exactly from the beginning, the operation at the point of resonance is not ensured, and the course of the demagnetizing current is dependent on the exposure of the coil to the objects to be demagnetized. The quality of the demagnetization procedure is therefore different from charge to charge and may not be controlled in an exact manner.

A method which avoids this disadvantage is described in DE 30 05 927 A1. Thereby, the frequency of the supply voltage of the coil at maximum frequency amplitude is shifted slowly from a starting value over the whole range of the possible resonant frequency which is unknown from charge to charge, and subsequently the voltage is reduced with a constantly reducing amplitude (FIG. 1) in the known manner. One disadvantage of this method lies in the fact that much time and thus energy is required for the approach to the resonant frequency. The activation of the coil voltage furthermore entails the disadvantage that the corresponding current is dependent on the ohmic resistance of the coil and thus on the temperature of the coil. This method too therefore does not ensure an exactly similar effect of the demagnetizing magnetic field from charge to charge.

All these described methods assume that the actual resonant frequency of the oscillation circuit charged with an object is not known. The frequency of the voltage source is either set in a fixed manner or is determined by a time program which is determined in a fixed manner. With the method of the fixed setting exists the danger that one accepts a considerable divergence and does not begin with the maximal current. In the programmed frequency course, at all events one runs through resonant frequency of the charged system, but one requires much time. For this reason, the method is less efficient in energy consumption and leads to an excess heating of the coil.

### SUMMARY OF THE INVENTION

It is therefore the object of the invention to find a method which does not have the above disadvantages.

The object is achieved in that the resonant frequency of the oscillation circuit with the demagnetization coil charged with any objects, may itself be determined in the shortest of times in an automatic and exact manner, so that a demagnetization procedure, for example according to EP 1465217, may begin directly with the exact resonant frequency. With this, one also ensures that the actual current values precisely follow the set current nominal value over the complete demagnetization process.

The advantage of the invention lies in the fact that no unnecessary time is required for passing through the resonant frequency for the beginning of the demagnetization procedure. The throughput of the demagnetization installation is significantly increased by way of this. Leadtime is no longer wasted for the demagnetization of a charge or of an object, and the procedure begins directly after the charging of the oscillation circuit with the correct resonant frequency. Thus a cycled demagnetization of different charges with respect to mass, material and configuration with correspondingly different resonant frequencies may be carried out without unnecessary delay and corresponding energy consumption.

### BRIEF DESCRIPTION OF THE DRAWINGS

The invention will be dealt with in the context of the drawings. There are shown in:

FIG. 1 the passing-through of the resonant point with the frequency of the supply voltage, according to the state of the art;

FIG. 2a the auxiliary coil for the measurement and setting of the resonant frequency;

FIG. 2b the measurement of the actual inductance of the demagnetization coil with an auxiliary coil;

FIG. 3a the frequency control loop of the demagnetization oscillation circuit;

FIG. 3b the dependence on the admittance and phase angle in the vicinity of the resonance point;

FIG. 3c phase position of voltage and current at the exit of the inverter; and

FIG. 3d shows the course of the current with self-oscillation of the frequency controller.

### DETAILED DESCRIPTION OF THE INVENTION

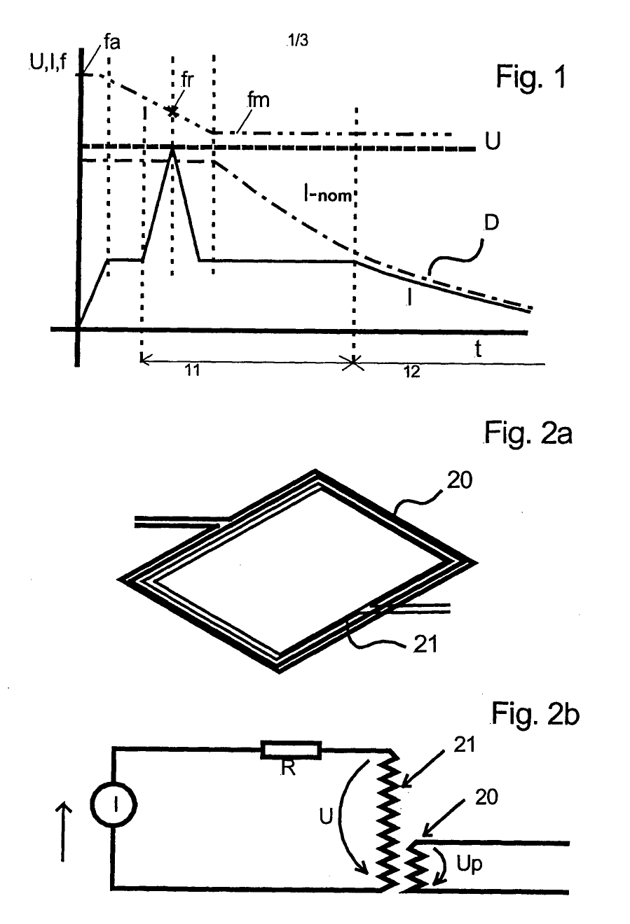

The course of the current I during the time t is represented in FIG. 1, according to the method according to DE 30 05 927 A1. The current course I is set against the optimal current course I-nom. In a first time interval 11, the demagnetization is effected in an uncontrolled manner on traveling through the resonant point at any location 12. A controlled demagnetization is effected with a controlled current only in the region of the second time interval. The decay of the curve D is only controlled and thus reproducible in the part section 12. The frequency is reduced from a high initial frequency fa to a demagnetisation frequency fm. Thereby, the resonant frequency fr is reached at some point therebetween.

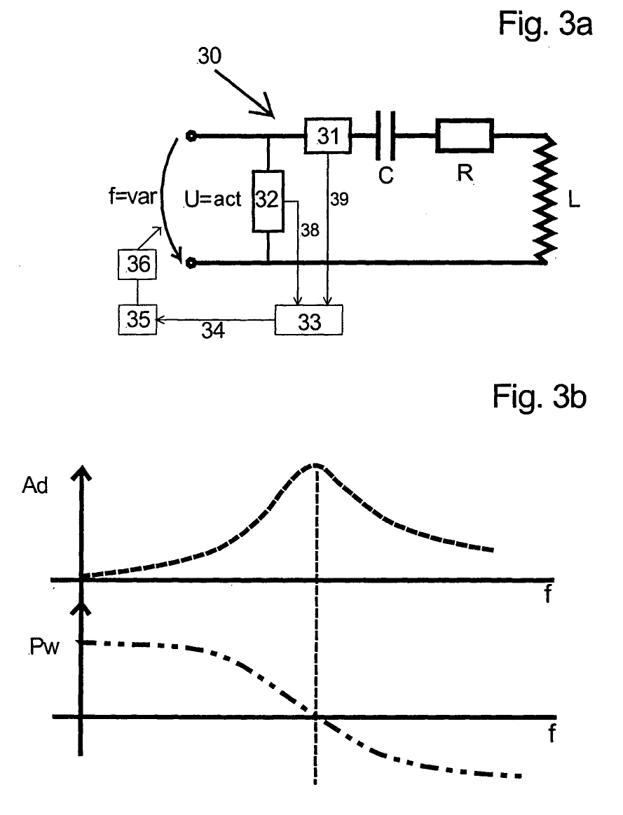

An alternative procedure according to FIG. 2a operates with an auxiliary coil or a low cross section, which determines the admittance of the auxiliary coil 21, and thus the inductance of the demagnetisation coil 20, and after further conversion, the corresponding resonant frequency. This produces no additional power loss in the coil and may be solved with a reasonable effort in an electronic manner. The auxiliary coil 21 must however be insulated with respect to the demagnetisation coil 20 for the highest occurring voltage in the demagnetisation cycle, and the evaluated resonant frequency is not accurate inasmuch as it is determined with very low currents where the permeability of the material to be demagnetized at all events is still not very effective. For this, a test with a charged coil is carried out before each demagnetisation. The resonant frequency is evaluated with a small test current. Up by way of the auxiliary coil 21. After this, the demagnetisation procedure is begun with a controlled demagnetisation current U and with the maximal demagnetisation current at resonant frequency.

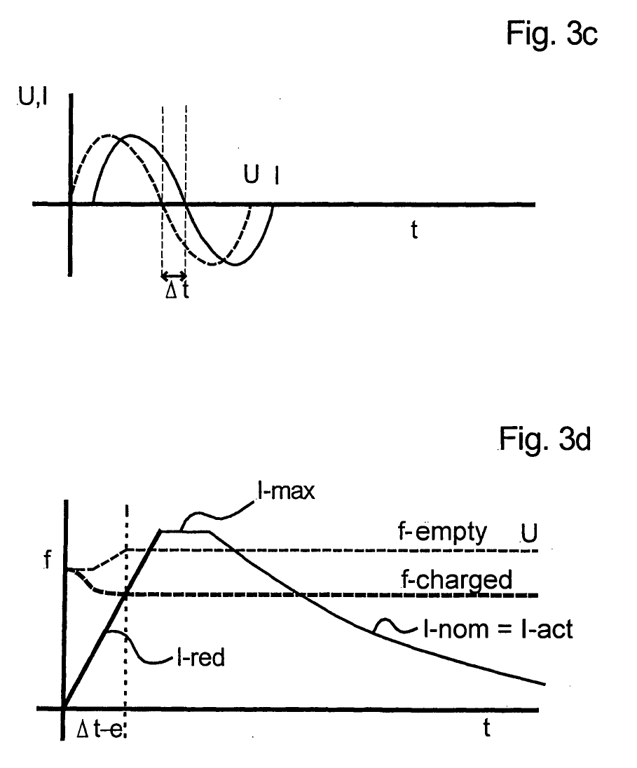

The preferred manner according to the invention (FIGS. 3a, 3b, 3c 3d) operates with a control loop which automatically maintains the output frequency of the inverter in the resonance point of the oscillation circuit. It is based on the measurement of the phase position of voltage and current at the exit of the inverter. If the supplied frequency is greater than the resonant frequency, the oscillation circuit acts in an inductive manner, i.e. the current lags the voltage, and the difference in the phase position of the current and voltage is negative. If the supplied frequency lies lower than the resonant frequency, the oscillation circuit behaves in a capacitive manner, and the current leads the voltage. The corresponding phase angle is positive. The sweeping of the phase angle is effected in the inverter itself by way of determining the zero crossings and their direction, of current and voltage. The two signals are required in the inverter in any case for its current control loop, i.e. for activation of the power stage. They are therefore available without extra expense. The tracking of the frequency on account of the phase angle only requires an additional part program, which is achieved purely by way of software.

The control loop 30 of the supply of the demagnetisation coil L is represented in FIG. 3a. The oscillation circuit consist of a capacitor C, a resistance R and the loaded coil L. The zero-crossing of the current 37 as well as the zero-crossing of the voltage 38 is detected with the measurement locations for current 31 and voltage 32. The phase angle 33 may be evaluated from the time difference of these zero-crossings 37 and 38. Thereupon, a corresponding correction signal 34 is given to the frequency setter 35. The frequency setter 35 then controls the inverter 36 to the corrected frequency.

The dependence on admittance and phase angle with a charged coil is evident from FIG. 3b. The frequency f is located on the x-axis and the admittance Ad as well as the phase angle Pw on the y-axis. The phase angle between the voltage and current at the feed point of the oscillation circuit goes through the zero point at the resonant frequency fr of the charged coil. This is the resonance point. A complete and reproducible demagnetisation is only possible on supplying the coil at this resonant frequency.

The phase position of the voltage U and the current I at the exit of the inverter is evident from FIG. 3c. The temporal difference of the two zero-crossings of voltage and current is indicated at Δt. One then controls the frequency of the inverter to Δt=0, or the phase angle to Φ=0

The course of the current with the leading transient oscillation phase Δt−e of the frequency controller at a reduced current I-red is evident from FIG. 3d. One can clearly recognize that the resonant frequency of the charged coil during the build-up of the current is achieved directly before the actual demagnetisation procedure. This is effected within a time of about 5 to 10 periods. Thereby, the current increases to the maximal nominal value I-max, in order subsequently to be reduced along the demagnetisation curve according to the known manner (EP 1465217).

The method may however also be applied with a coil subjected to continuous current (tunnel-demagnetizer) by way of constantly retaining the frequency in the resonance point and tracking it, during the passage of the material through the coil. For this, the coil of the tunnel-demagnetizer is fed with continuous current, wherein the frequency is automatically held in the resonance point and tracked, during the passage of the material through the coil.

1. A method for setting the resonant frequency for demagnetizing objects in the region of a coil, wherein an object is located within an alternating field during a retention time of a certain duration, and wherein the coil is part of an oscillation circuit which is fed in a current-controlled manner by way of an inverter, and wherein the current is controlled during the demagnetisation, and wherein the oscillation circuit from an initial frequency is brought to the resonant frequency of the oscillation circuit charged with the object, before the current of the oscillation circuit according to a demagnetisation function is reduced from a nominal current to an end current, wherein,
either the admittance of the oscillation circuit charged with the object is measured by way of a separate measurement coil with a small measurement current, whereupon the frequency in the oscillation circuit for the demagnetisation impulse is set to the value evaluated therefrom or
the resonant frequency of the oscillation circuit charged with the object is evaluated and controlled-in, during a time duration of at least 5 periods during the increase of the demagnetisation current, whereupon the frequency in the oscillation circuit is continuously tracked to the resonance point.

2. A method according to claim 1, wherein the zero-crossings of voltage and current of the oscillation circuit are detected, and the phase angle is determined from the time difference of these zero-crossings, whereupon a corresponding correction signal is given to a frequency setter which sets the frequency of the current of the oscillation circuit, controlled by the inverter, to the resonant frequency.

3. A method according to claim 1, wherein firstly a test current is given to the auxiliary coil, whereupon the resonant frequency of the charged oscillation circuit is determined, whereupon the test current of the auxiliary coil is switched off and the supply of the oscillation circuit is started under resonant frequency.

4. A method according to claim 1, wherein the coil is a tunnel-demagnetizer and is fed with continuous current, wherein the frequency, given the passage of the material through the coil, is automatically held and tracked in the resonance point, in that the zero-crossings of the voltage and current of the oscillation circuit are detected, and the phase angle is determined from the time difference of these zero-crossings, whereupon a corresponding correction signal is given to a frequency setter which sets the frequency of the current of the oscillation circuit, controlled by the inverter, to the resonant frequency.
